(19) United States
(12) Patent Application Publication
(10) Pub. No.: US 2008/0022898 A1
(43) Pub. Date: Jan. 31, 2008

(54) WATER-BORNE COATING COMPOSITION FOR AUTOMOTIVE INTERIOR SUBSTRATES

(75) Inventors: Takahisa SUDO, Toyota-shi (JP); Hirofumi YAMASHITA, Hirakata-shi (JP); Shinnosuke KAWANO, Hirakata-shi (JP); Yoshihiko SAITO, Hirakata-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: TOYOTA JIDOSHA KABUSHIKI KAISHA, Toyota-shi (JP); NIPPON BEE CHEMICAL CO., LTD., Hirakata-shi (JP)

(21) Appl. No.: 11/830,476

(22) Filed: Jul. 30, 2007

(30) Foreign Application Priority Data
Jul. 31, 2006 (JP) 2006-207799

(51) Int. Cl. C08L 75/00

(52) U.S. Cl. 106/287.25

(57) ABSTRACT

The present invention to provide a water-borne coating composition for automotive interior substrates, which can form a coating film which is superior in an adhesion property on a plastic substrate by baking to dry at low temperatures of about 60° C., and can further attain a coating film which is also superior in a soft feeling, beef tallow resistance, chemical resistance and abrasion resistance. A water-borne coating composition for automotive interior substrates including a water-borne urethane resin (A), a water-borne chlorinated polyolefin modified acrylic resin (B), a water-borne polyolefin resin (C) and elastic particles (D), wherein the content of said resin (C) is 15 to 50% by weight when the total weight of said resin (A), resin (B) and resin (C) is taken as 100% by weight, a solid weight ratio [(A)/(B)] of said resin (A) and resin (B) is 90/10 to 50/50, said resin (A) has an elongation percentage of 100% or more at 20° C., an amount of chlorinated polyolefin modified segment in said resin (B) is 5 to 40% by weight, and said resin (C) is a water-borne polypropylene resin that is not chlorinated, and has crystallinity of 35 to 50% and a weight average molecular weight of 50000 to 200000.

### TECHNICAL FIELD

The present invention relates to a water-borne coating composition for automotive interior substrates.

### BACKGROUND ART

Plastic substrates are widely used as automotive interior parts such as instrument panels, center consoles, door trims and the like. It is common to coat plastic substrates used for such applications for the purpose of imparting performance such as a soft feeling (feeling of high quality of achieving a dry feeling and a wet feeling simultaneously), beef tallow resistance, chemical resistance, and abrasion resistance. And, since coating is applied to a plastic substrate, it is necessary that a coating film having a high adhesion property can be attained by drying at low temperatures after applying the coating composition to the plastic.

Conventionally, in polyolefin plastic substrates, chlorinated polypropylene has been employed as a component in a coating composition in order to achieve a high adhesion property by drying at low temperatures, but in the chlorinated polypropylene, there is no way other than a method of increasing the chlorine content for lowering a softening point. However, when the chlorine content becomes high, since an SP value of the chlorinated polypropylene becomes large, difference of surface tension between the coating film and a substrate increases and a strong adhesion force cannot be expected. And, since the solubility in a solvent increases in proportion to the chlorine content, not only the beef tallow resistance is deteriorated, but also the hardness of the coating film increases and a soft feeling tends to be lost. Accordingly, development of a coating composition which can attain all performance described above is desired.

For example, as a coating used for a surface modification method of automotive plastic parts, two package urethane coating composition, by which a coating film having an elongation percentage of 60 to 100% can be obtained, is known (See Japanese Kokai Publication Hei-9-253577). And, as a coating composition used for coating a polyolefin substrate, a coating composition including acrylic modified chlorinated polyolefin is also known (See Japanese Kokai Publication 2005-290314). But, since coating compositions disclosed in these patents are an organic solvent type coating, environmental burden was large. And, in Japanese Kokai Publication 2005-290314, it is not disclosed to use a water-borne polyolefin resin and the beef tallow resistance is low.

As a water-borne primer coating composition for polypropylene substrates, a coating composition including a modified polyolefin resin converted to a water-borne resin, which is modified with α,β-unsaturated dicarboxylic acid or the like and has a number average molecular weight of 4000 to 30000 and a degree of chlorination of 0 to 30% by weight, an acrylic resin converted to a water-borne resin, and a polyurethane resin converted to a water-borne resin is known (See Japanese Kokai Publication Hei-6-336568).

However, this is a primer coating composition and not a top coating composition realizing performance such as a soft feeling. And, it is not disclosed to use a water-borne chlorinated polyolefin modified acrylic resin. It is described to use a simple acrylic resin, but this coating composition has low compatibility with a polyolefin resin, and a clear coating composition composed of only resins is whitish, and when a coating film is formed from this coating composition, the coating film is also whitish. In this coating composition, the respective resins do not intermingle with each other in a microscopically homogeneous state, and there may be a problem with adhesion property or beef tallow resistance. Further, a glass transition temperature of the acrylic resin is set at low temperature of −50° C. to +20° C., and in a coating film for automotive interior substrates using this coating composition, there is a possibility that the beef tallow resistance or the abrasion resistance is deteriorated. Further, as for a coating line, conventional drying of a solvent type coating composition and a water-borne coating composition is carried out at 70 to 80° C. as described in Examples of the above-mentioned Patent Documents, but drying at lower temperature is desired from the viewpoint of energy saving, and particularly from the viewpoint of environmental protection, expectations for a water-borne coating composition and drying at low temperature are high.

### DISCLOSURE OF THE INVENTION

### Problems to be Solved by the Invention

In view of the above state of the art, it is an object of the present invention to provide a water-borne coating composition for automotive interior substrates, which can form a coating film which is superior in an adhesion property on a plastic substrate by baking to dry at low temperatures of about 60° C., and can further attain a coating film which is also superior in a soft feeling, beef tallow resistance, chemical resistance and abrasion resistance.

### Means for Solving the Problems

The present invention pertains to a water-borne coating composition for automotive interior substrates including a water-borne urethane resin (A), a water-borne chlorinated polyolefin modified acrylic resin (B), a water-borne polyolefin resin (C) and elastic particles (D), wherein the content of the resin (C) is 15 to 50% by weight when the total weight of the resin (A), resin (B) and resin (C) is taken as 100% by weight, a solid weight ratio [(A)/(B)] of the resin (A) and resin (B) is 90/10 to 50/50, the resin (A) has an elongation percentage of 100% or more at 20° C., an amount of chlorinated polyolefin modified segment in the resin (B) is 5 to 40% by weight, and the resin (C) is a water-borne polypropylene resin that is not chlorinated, and has crystallinity of 35 to 50% and a weight average molecular weight of 50000 to 200000.

The resin (C) is preferably obtained by using a metallocene catalyst.

The resin (C) preferably has an elongation percentage of 400% or more at 20° C.

The resin (C) is preferably modified with an unsaturated organic acid or acid anhydride thereof.

A solid weight ratio of (D)/[(A)+(B)+(C)] is preferably in a range of 20/100 to 100/100.

In the resin (B), a glass transition temperature (Tg) of an acrylic polymerization chain segment is preferably 50 to 120° C.

Hereinafter, the present invention will be described in detail.

A water-borne coating composition for automotive interior substrates of the present invention (hereinafter, also referred to as just a “water-borne coating composition”) can be suitably used for plastic substrates such as polyolefin and the like, and it can be particularly suitably used for a polyolefin substrate. Therefore, it is suitable for coating automotive interior parts such as instrument panels, center consoles, door trims and the like.

The water-borne coating composition of the present invention includes the water-borne urethane resin (A), the water-borne chlorinated polyolefin modified acrylic resin (B) having a chlorinated polyolefin modified segment in an amount of 5 to 40% by weight, the water-borne polypropylene resin (C) that is not chlorinated, having crystallinity of 35 to 50% and a weight average molecular weight of 50000 to 200000, and elastic particles (D) in specific composition. Since the water-borne coating composition of the present invention is a coating composition including such components in specific composition, it can form a coating film having an excellent adhesion property on a plastic substrate by baking to dry at low temperatures. And, a soft feeling, beef tallow resistance, chemical resistance and abrasion resistance of a coating film to be obtained are excellent.

The water-borne coating composition of the present invention can attain a coating film having performance described above by being applied directly onto a substrate and baked to dry at low temperatures. Therefore, if the water-borne coating composition is employed, a step of applying a primer can be omitted.

The water-borne coating composition of the present invention includes the water-borne polyolefin resin (C). The resin (C) is a component composing of a matrix of the coating film and can be melted by heat. The content of the resin (C) is 15 to 50% by weight when the total weight of the resin (A), resin (B) and resin (C) is taken as 100% by weight, and preferably 20 to 40% by weight. When the content of the resin (C) is less than 15% by weight, the adhesion of a coating film to be obtained to a substrate may be poor, and when the content is more than 50% by weight, a SP value of a coating film to be obtained becomes close to a SP value of beef tallow, and therefore there is a possibility that the coating film tends to contain beef tallow and becomes low in beef tallow resistance.

The resin (C) has crystallinity of 35 to 50%. When the crystallinity is less than 35%, a coating film becomes amorphous and the beef tallow resistance of the coating film may be deteriorated, and when the crystallinity is higher than 50%, melting of the resin (C) becomes difficult and the adhesion of a coating film to be obtained to a substrate may be poor.

In the present description, a measuring method of the crystallinity is as follows.

(Crystallinity)

The stereoregularity [mmmm] of polypropylene was measured by ¹³C-NMR spectrometry using an NMR apparatus (manufactured by JEOL Ltd., 400 MHz). 350 to 500 mg of samples were completely dissolved with about 2.2 ml of o-dichlorobenzene in a sample tube for NMR of 10 mm in diameter. Next, about 0.2 ml of benzene deuteride was added as a lock solvent, and after homogenizing the resulting mixture, the stereoregularity was measured at 130° C. by a proton complete decoupling method. As for measuring conditions, a flip angle was 90° and a pulse pitch was 5T₁ or more (T₁ is the longest time of spin-lattice relaxation times of a methyl group). In propylene polymers, since spin-lattice relaxation times of a methylene group and a methyne group are shorter than that of a methyl group, the recovery of magnetization of all carbons is 99% or more in these measuring conditions. The stereoregularity was measured by integrating spectra for 20 hours or more.

As for chemical shifts, a chemical shift of a peak based on a methyl group which is a third unit in five propylene unit chains having the same absolute configurations of a methyl branch, that is, expressed by mmmm among 10 species of pentads (mmmm, mmmr, rmmr, mmrr, mmrm, rmrr, rmrm, rrrr, rrrm, and mrrm) in a propylene unit chain portion consisting of head to tail bonds is set at 21.8 ppm, and on the basis of this, chemical shifts of other carbon peaks are determined. In accordance with this basis, in the case of five other propylene unit chains, a chemical shift of a peak based on a methyl group which is a third unit are generally as follows. That is, mmmr: 21.5 to 21.7 ppm, rmmr: 21.3 to 21.5 ppm, mmrr: 21.0 to 21.1 ppm, mmrm and rmrr: 20.8 to 21.0 ppm, rmrm: 20.6 to 20.8 ppm, rrrr: 20.3 to 20.5 ppm, rrrm: 20.1 to 20.3 ppm, and mrrm: 19.9 to 20.1 ppm.

With respect to this polypropylene main chain, a ratio (S₁/S) of an area S₁ of the peak in which 21.8 ppm is a peak top to the total area S of the peaks belonging to the pentads appearing in a range of 19.8 ppm to 22.2 ppm when a chemical shift of a peak top of a peak belonging to the pentad expressed by mmmm is set at 21.8 ppm, that is, all pentads of mmmm, mmmr, rmmr, mmrr, mmrm, rmrr, rmrm, rrrr, rrrm, and mrrm was defined as the crystallinity.

In addition, in the present description, since the crystallinity is measured according to the method described above, the crystallinity of a copolymer of propylene and another monomer means the crystallinity of a polypropylene segment in a resin.

A weight average molecular weight of the above resin (C) is 50000 to 200000. When the weight average molecular weight is less than 50000, the adhesion property and the beef tallow resistance of a coating film may be deteriorated due to reduction in a cohesive force of a coating film. When the weight average molecular weight is more than 200000, it becomes difficult to make a resin water-borne and this will interfere with production of a water-borne resin.

In this description, a measuring method of the weight average molecular weight is as follows.

(Weight Average Molecular Weight)

First, 20 mg of a sample was put into a 30 ml vial bottle, and to this, 20 g of o-dichlorobenzene containing BHT in an amount of 0.04% by weight as a stabilizer was added. The sample was dissolved using an oil bath heated to 135° C., and then thermally filtrated with a PTFE (polytetrafluoroethylene) filter with a bore size of 3 μm to prepare a sample solution having a polymer concentration of 0.1% by weight. Next, the weight average molecular weight was measured by a gel permeation chromatography (GPC) method using GPC 150CV manufactured by Nihon Waters K.K. equipped with TSKgel GM H-HT (30 cm×4) as a column and a refractive index (RI) detector. As measuring conditions, injection rate of a sample solution: 500 μl, column temperature: 135° C., solvent: o-dichlorobenzene, and an eluent flow rate: 1.0 ml/min were employed.

On the determination of a molecular weight, commercially available monodispersed polystyrene was used as a standard sample to derive the molecular weight on this polystyrene standard sample equivalent basis.

The resin (C) is a water-borne polypropylene resin that is not chlorinated. The present invention uses the water-borne polypropylene resin that is not chlorinated, but it can enhance an adhesion property of a coating film to be obtained to a substrate in baking to dry at low temperatures. Examples of the water-borne polyolefin resin that is not chlorinated include a monopolymer of propylene and a copolymer of propylene and a monomer (ethylene etc.) which can be copolymerized with propylene and does not contain chlorine.

The resin (C) is preferably a polypropylene resin in which 90% by weight or more of a constituent monomer is propylene. When a ratio of propylene is less than 90% by weight in the polypropylene resin, a crystallinity segment of a resin becomes small, and the beef tallow resistance of the coating film may be deteriorated.

In the above-mentioned polypropylene resin, examples of constituent monomers other than propylene include monoolefins or diolefins having 2 or 4 to 20 carbon atoms such as butene, pentene, hexene, octene, decene, butadiene, hexadiene, octadiene, cyclobutene, cyclopentene, cyclohexene, norbornene, norbornadiene, styrene and derivatives thereof. In the present description, the contents of monomers composing of a resin can be determined from the amounts of monomers used for producing the resin.

The resin (C) is preferably obtained by using a metallocene catalyst. This means that the metallocene catalyst can generally control microtacticity by ligand design, that is, the resulting polypropylene main chain contains an isotactic block having a chain length which can be crystallized in contrast to atactic polypropylene, and the existence of the isotactic block, in other words, means that blocks consisting of sequences having disordered stereospecificity exist simultaneously in the main chain. That is, blocks having the crystallinity and amorphous blocks coexist in the polypropylene main chain formed by polymerization using the metallocene catalyst, and the block having the crystallinity is composed of the isotactic block having a relatively long mean chain length and has a unique structure that is a highly isotactic structure. By such a characteristic, in the coating composition using polyolefin formed by polymerization using the metallocene catalyst, it becomes possible to achieve simultaneously the beef tallow resistance, the adhesion property, and the soft feeling by the control of an elongation percentage of a coating film to be obtained even at low temperatures.

As the metallocene catalyst, publicly known catalysts can be used, and examples of the catalysts include a catalyst described in Japanese Kokai Publication 2004-115712 (paragraphs [0021] to [0052]).

The resin (C) is preferably a substance modified (hereinafter, it may be referred to as a modified polypropylene resin) with an unsaturated organic acid or acid anhydride thereof. Examples of the above-mentioned substances modified with an unsaturated organic acid or acid anhydride thereof include substances modified by grafting an unsaturated carboxylic acid having 3 to 25 carbon atoms or acid anhydride thereof onto the main chain of above polypropylene resin. This graft reaction can be performed by a normal method using a radical generator.

Examples of the unsaturated carboxylic acid or acid anhydride thereof to be grafted include maleic acid, fumaric acid, itaconic acid, tetrahydrophthalic acid, citraconic acid, crotonic acid, allylsuccinic acid, mesaconic acid, aconitic acid, and anhydrides thereof, and among others, maleic acid and maleic anhydride are preferred.

A ratio of addition of the unsaturated carboxylic acid or acid anhydride thereof of the modified polypropylene resin (a content of the unsaturated carboxylic acid or acid anhydride thereof in the modified polypropylene resin), which can be used for the present invention, is 0.01 to 20% by weight, and preferably 0.1 to 5% by weight. When this ratio of addition is less than 0.01% by weight, a dispersed particle of a water-borne coating composition to be obtained has a large particle diameter and the dispersion stability of the particles tends to be defective, and when the ratio of addition is more than 20% by weight, the water resistance of a coating film tends to be deteriorated. This ratio of addition can be measured by comparing absorption intensity of a carbonyl group with an absorption intensity calibration curve of a carbonyl group which has been prepared based on samples having known ratios of addition (contents) by infrared spectroscopic analysis.

As a method of adding the unsaturated carboxylic acid or acid anhydride thereof, a method of performing the graft reaction by subjecting a resin to the decomposition conditions of a radical generator in the presence of the radical generator is common, and examples of this method include a method in which a polypropylene main chain is dissolved in an organic solvent, and to this, the unsaturated carboxylic acid or acid anhydride thereof and the radical generator are added, and the resulting mixture is heated while stirring to perform addition, and a method of supplying components to an extruder and performing addition while heating and kneading the components.

A molar ratio of the radical generator to be used to the unsaturated carboxylic acid or acid anhydride thereof to be used (a ratio of the radical generator to the unsaturated carboxylic acid or acid anhydride thereof) is usually 1/100 to 3/5, preferably 1/20 to 1/2, and a reaction temperature is not particularly limited, but it is usually 50° C. or higher, preferably 80 to 200° C. A reaction time is usually 2 to 10 hours.

The radical generator used for the graft reaction can be appropriately selected from common radical generators to be used, and includes, for example, organic peroxides. Examples of the organic peroxides include diisopropyl peroxide, di(t-butyl)peroxide, tert-butyl hydroperoxide, benzoyl peroxide, dicumyl peroxide, cumyl hydroperoxide, dilauroyl peroxide, dibenzoyl peroxide, methyl ethyl ketone peroxide, cyclohexanone peroxide, cumene hydroperoxide, diisopropyl peroxycarbonate, dicyclohexyl peroxycarbonate, and tert-butyl peroxyisopropylmonocarbonate. Among these peroxides, di(t-butyl)peroxide, dicumyl peroxide, and tert-butyl peroxyisopropylmonocarbonate are preferred.

Examples of an organic solvent used in performing a graft reaction in a state of dissolution or impregnation include aromatic hydrocarbons such as benzene, toluene, xylene and the like, aliphatic hydrocarbons such as hexane, heptane, octane, decane and the like, and halogenated hydrocarbons such as trichloroethylene, perchloroethylene, chlorbenzene, o-dichlorobenzene and the like, and among these solvents, aromatic hydrocarbons and halogenated hydrocarbons are preferred and particularly toluene, xylene, and chlorbenzene are preferred.

And, when a modified polypropylene resin having unsaturated dicarboxylic monoester as a modifying component is produced, it can be produced by a method of grafting unsaturated dicarboxylic monoester onto a polypropylene main chain as described above, and in addition by a method of grafting unsaturated dicarboxylic acid or anhydride thereof onto a polypropylene main chain and then esterifying one of carboxyl groups with aliphatic alcohol or monoesterifying an acid anhydride group.

Preferably, the resin (C) has a melting point of 50 to 90° C. When the melting point is less than 50° C., the beef tallow resistance of a coating film to be obtained may be deteriorated. When the melting point is more than 90° C., the adhesion property of a coating film to be obtained to a substrate may be poor. And, when the above melting point is within the above range, a coating film which is superior in an adhesion property and fouling resistance can be attained by baking to dry at low temperatures. The melting point is more preferably 55 to 75° C.

In the present description, a measuring method of the melting point (° C.) of the resin (C) is as follows.

(Measuring Method of Melting Point)

Values measured according to the following steps using a differential scanning calorimeter (DSC) (thermal analyzer SSC 5200 manufactured by Seiko Instruments Inc.) were used. That is, in the step of raising temperature from 20° C. to 150° C. at a temperature raising rate of 10° C./min (step 1), the step of lowering temperature from 150° C. to −50° C. at a temperature lowering rate of 10° C./min (step 2), and the step of raising temperature from −50° C. to 150° C. at a temperature raising rate of 10° C./min (step 3), temperature indicated by an arrow of a chart of FIG. 1 in raising temperature of the step 3 was selected as a melting point.

The resin (C) preferably has an elongation percentage of 400% or more at 20° C. When the elongation percentage is within the above range, a soft feeling (especially, wet feeling) of a coating film to be obtained can be improved. The elongation percentage is more preferably 500% or more, and it may be 1000% or less as long as it is within the above range.

In the present description, a measuring method of the elongation percentage (%) of the resin (C) is as follows.

A resin is applied to a polypropylene plate so as to be 25 μm in a dried film thickness with a spray gun, and baked at 60° C. for 20 minutes, and a test piece of 10 mm in width and 50 mm in length is cut off from the resulting polypropylene plate, and an elongation percentage is measured at a temperature of 20° C., at a tensile speed of 50 mm/min. Shimadzu Autograph AG-IS MS manufactured by SHIMADZU CORPORATION is used for measurement.

A method of converting the resin (C) to a water-borne resin is not particularly limited and publicly known methods can be employed. Examples of the methods include a method in which toluene is added to the produced acid anhydride modified polypropylene described above to dissolve the polypropylene at about 100° C. to form a resin solution, and then a surfactant is added to this resin solution, and to the resulting mixture, deionized water of about 50° C. is added dropwise while forced stirring the resulting mixture in a state of about 50 to 60° C. to emulsify the mixture through phase inversion, and then toluene is removed under reduced pressure. And, examples of the methods include a method in which the above-mentioned acid anhydride modified polypropylene resin is heated and dissolved with a solvent such as tetrahydrofuran at about 60° C., and after a carboxyl group of the above-mentioned resin is neutralized with excessive amine, deionized water of about 60° C. is added dropwise to this resin solution while forced stirring the resin solution to emulsify the mixture through phase inversion, and then the solvent is removed under reduced pressure. Further, there is also a method in which an emulsifier and amine are mixed together into the above-mentioned dissolved solution, and to the resulting mixture, deionized water of about 60° C. is added dropwise while forced stirring the mixture to emulsify the mixture, and then the solvent is removed under reduced pressure. There is also a method in which in contradiction to the above-mentioned procedure, the above-mentioned acid anhydride modified polyolefin solution formed by dissolving it with the above heated solvent is added dropwise to hot water, in which a neutralizer such as amine and/or a surfactant is dissolved, while forced stirring the hot water to emulsify the resulting mixture, and then the solvent is removed under reduced pressure.

The water-borne coating composition of the present invention includes the water-borne urethane resin (A). The resin (A) is a component composing of a matrix of the coating film and can be melted by heat. By adding the resin (A), a soft feeling and abrasion resistance of the obtained coating film can be improved.

An amount of the resin (A) to be mixed is preferably 25 to 75% by weight when the total weight of the resin (A), resin (B) and resin (C) is taken as 100% by weight. When the amount of the resin (A) to be mixed is less than 25% by weight, a soft feeling of the obtained coating film may be poor, and when it is more than 75% by weight, the adhesion property of the obtained coating film to a substrate may be poor.

The resin (A) preferably has an elongation percentage of 100% or more at 20° C. When the elongation percentage is within the above range, a soft feeling of a coat to be obtained can be improved. The elongation percentage is more preferably 200% or more, and it may be 1000% or less as long as it is within the above range.

Examples of the resin (A) include an urethane dispersion prepared by adding deionized water to an urethane prepolymer, which is obtained by reacting a polyfunctional isocyanate compound, a polyol having two or more hydroxyl groups in a molecule, and a hydrophilizing agent having both a hydroxyl group and a carboxylic acid group such as dimethylolpropanediol or dimethylolbutanediol in a state of excessive isocyanate groups in the presence of a catalyst such as dibutyl tin dilaurate or the like and then neutralizing a carboxylic acid with an organic base such as an amine or an inorganic base such as potassium hydroxide, sodium hydroxide or the like, to convert to a water-borne prepolymer, and increasing a molecular weight of the prepolymer with a chain extender; an urethane dispersion prepared by synthesizing an urethane prepolymer containing no carboxylic acid, extending a chain with diol or diamine, having a hydrophilic group such as carboxylic acid, sulfonic acid and ethylene glycol, neutralizing with the above-mentioned basic substance to convert a resin to a water-borne resin, and further increasing a molecular weight of the resin using a chain extender as required; and an urethane dispersion obtained by using an emulsifier together as required.

Examples of the above-mentioned polyfunctional isocyanate compound include polyfunctional isocyanate compounds such as diisocyanate compounds, for example, 1,6-hexanediisocyanate, lysine diisocyanate, isophorone diisocyanate, cyclohexane-1,4-diisocyanate, xylylene diisocyanate, 2,4-trilene diisocyanate and 2,6-trilene diisocyanate, and adducts, biurets and isocyanurate thereof. And, examples of the polyols include polyester polyols, polyether polyols and polycarbonate polyols.

Examples of the above-mentioned chain extender include low molecular weight diol compounds such as ethylene glycol, propylene glycol, 1,4-butanediol, neopentyl glycol, furanedimethanol, diethylene glycol, triethylene glycol and tetraethylene glycol, and polyetherdiol compounds prepared by polymerizing by addition of ethylene oxide, propylene oxide, tetrahydrofuran or the like to these diol compounds; polyesterdiols having a hydroxyl group at an end, which are obtained from the above-mentioned low molecular weight diol compounds, dicarboxylic acid such as succinic acid (anhydride), adipic acid and phthalic acid (anhydride), and anhydrides thereof; polyhydric alcohols such as trimethylol ethane and trimethylol propane; aminoalcohols such as monoethanolamine, diethanolamine and triethanolamine; diamine compounds such as ethylenediamine, propylenediamine, butylenediamine, hexamethylene diamine, phenylenediamine, toluenediamine, xylylenediamine and isophorone diamine; and water, ammonia, hydrazine and dibasic acid hydrazide.

As the resin (A), commercially available urethane dispersions can also be used. The above-mentioned commercially available urethane dispersion is not particularly limited, and examples of the urethane dispersion include ADEKA BONTIGHTER HUX-561, ADEKA BONTIGHTER HUX-210, ADEKA BONTIGHTER HUX-980 (all produced by ADEKA Corporation), Bayhydrol VP LS2952 (produced by Sumika Bayer Urethane Co., Ltd.), VONDIC 2260, VONDIC 2220, HYDRAN WLS210, HYDRAN WLS213 (all produced by DAINIPPON INK AND CHEMICALS, INC.), and NeoRez R9603 (produced by Avecia Ltd.).

The water-borne coating composition of the present invention includes the water-borne chlorinated polyolefin modified acrylic resin (B). The resin (B) is a component composing of a matrix of the coating film and can be melted by heat. The resin (B) becomes a resin making the above-mentioned polyolefin resin compatible with a urethane resin with its grafted segment having a low SP value and acrylic main chain segment having a relatively high SP value for the purpose of avoiding layer separation and nonuniform distribution between a polypropylene resin having a low SP value and a urethane resin having a relatively high SP value, and a three component resin forms a microscopically homogeneous resin film. Furthermore, the water-borne coating composition of the present invention can impart the excellent abrasion resistance and the excellent adhesion property to a substrate to a coating film to be formed by containing the above resin (B).

An amount of the resin (B) to be mixed is preferably 5 to 42% by weight when the total weight of the resin (A), resin (B) and resin (C) is taken as 100% by weight. When the amount of the resin (B) to be mixed is less than 5% by weight, the uniformity of mixing of the urethane resin (A) and the polypropylene resin (C) is deteriorated, and therefore the adhesion to a substrate and the abrasion resistance may be deteriorated, and when it is more than 42% by weight, a soft feeling may be poor.

Examples of polyolefin used for the production of the above-mentioned water-borne chlorinated polyolefin modified acrylic resin include chlorinated products of polyethylene, polypropylene, ethylene-propylene copolymer, ethylene-propylene-diene copolymer, polybutene, and copolymers such as styrene-butadiene-isoprene.

An acrylic polymerization chain segment in the above-mentioned water-borne chlorinated polyolefin modified acrylic resin is a polymerization chain grafted onto a polyolefin segment or a block polymerization chain attached to an end of polyolefin. The glass transition temperature (Tg) of the above-mentioned acrylic polymerization chain segment is preferably 50 to 120° C. When the Tg is lower than 50° C., the abrasion resistance and the beef tallow resistance of a coating film to be obtained may be deteriorated, and when it is higher than 120° C., since a film formation property is poor, the water resistance and the soft feeling of a coating film to be obtained may be deteriorated. The Tg is more preferably 70 to 100° C.

In the present description, a glass transition temperature (Tg) is a value derived from a chart in raising temperature of the step 3 obtained by the same method as the above-mentioned measuring method of melting point. That is, a temperature indicated by an arrow of a chart shown in FIG. 2 was selected as a Tg.

The above-mentioned acrylic polymerization chain segment contains constituent units derived from an acrylic monomer as an essential component, but it may be a copolymer segment appropriately further containing constituent units derived from other monomers. Examples of the acrylic monomer include (meth) acrylic ester monomers such as acrylic acid, methacrylic acid and (meth) acrylic monomer. Examples of the other monomers include styrenic monomers such as styrene and α-methylstyrene, and hydroxyl group-containing vinyl monomers such as 4-hydroxybutylvinyl ether.

Examples of the (meth)acrylic ester monomers include (meth) acrylic ester monomers having an alkyl group having 1 to 12 carbon atoms, for example, methyl (meth)acrylate, ethyl (meth)acrylate, n-propyl (meth)acrylate, isopropyl (meth)acrylate, n-butyl (meth)acrylate, isobutyl (meth)acrylate, t-butyl (meth)acrylate, pentyl (meth)acrylate, hexyl (meth)acrylate, cyclohexyl (meth)acrylate, octyl (meth)acrylate and 2-ethylhexyl (meth)acrylate, nonyl (meth)acrylate, decyl (meth)acrylate, and dodecyl (meth)acrylate, and include (meth)acrylic ester monomers having an aryl group or an arylalkyl group having 6 to 12 carbon atoms, for example, phenyl (meth)acrylate, toluoyl (meth)acrylate, and benzyl (meth)acrylate. Incidentally, in the present description, the expression of “(meth)acrylic” means “acrylic or methacrylic”.

Examples of the (meth)acrylic ester monomers further include (meth)acrylic ester monomers having an alkyl group containing a heteroatom, which have 1 to 20 carbon atoms, for example, dimethylaminoethyl (meth)acrylate, diethylaminoethyl (meth)acrylate, 2-aminoethyl (meth)acrylate, 2-hydroxyethyl (meth)acrylate, hydroxypropyl (meth)acrylate, 2-methoxyethyl (meth)acrylate, 3-methoxypropyl (meth)acrylate, glycidyl (meth)acrylate and adducts of (meth)acrylate ethyleneoxide; (meth)acrylic ester monomers having an alkyl group containing a fluorine atom, which have 1 to 20 carbon atoms, for example trifluoromethylmethyl (meth)acrylate, 2-trifluoromethylethyl (meth)acrylate and 2-perfluoroethylethyl (meth)acrylate; and (meth)acrylamide monomers, for example, (meth)acrylamide and (meth)acryldimethylamide.

Examples of a method of producing the above-mentioned water-borne chlorinated polyolefin modified acrylic resin include a method in which chlorinated polyolefin is dissolved in a solvent, and in the resulting solution, an acid-containing acrylic monomer such as (meth)acrylic acid is copolymerized with other acrylic monomer in the presence of peroxide to graft-copolymerize the resulting copolymer onto the chlorinated polyolefin, and then graft-copolymerized resin is neutralized with an amine, and to this, deionized water was added to convert the graft-copolymerized resin to a water-borne resin, and an emulsion polymerization method or fine suspension polymerization method in which the above-mentioned chlorinated polyolefin and an acrylic monomer are previously emulsified with an emulsifier, and then the resulting emulsion is polymerized using a polymerization initiator.

As for the resin (B), an amount of chlorinated polyolefin modified segment in the resin (B) is in a range of 5 to 40% by weight. When the amount of chlorinated polyolefin modified segment in the resin (B) is less than 5% by weight, the compatibility of the resin (B) with the urethane resin (A) and the polypropylene resin (C) may be deteriorated, and consequently the inside of a coating film becomes nonuniform and the adhesion property and the abrasion resistance may be deteriorated. When the amount of chlorinated polyolefin modified segment in the resin (B) is more than 40% by weight, the beef tallow resistance may be deteriorated. The above amount of modified segment can be calculated from the amount to be mixed.

In the water-borne coating composition of the present invention, the solid weight ratio [(A)/(B)] of the resin (A) and resin (B) is 90/10 to 50/50, and preferably 80/20 to 60/40. When the above (A)/(B) is more than 90/10, the adhesion property of a coating film to be obtained to a substrate may be poor, and when it is less than 50/50, the soft feeling of a coating film to be obtained may become insufficient.

The water-borne coating composition of the present invention includes elastic particles (D). By containing the elastic particles (D), a coating composition which can form a coating film having an excellent soft feeling (wet feeling and dry feeling) can be obtained. The elastic particles (D) is not particularly limited as long as it is a publicly known particle capable of imparting the soft feeling to the coating film, but urethane resin beads are preferably used.

The above-mentioned urethane resin beads preferably have a mean particle diameter of 5 to 25 μm. The resin beads more preferably have a mean particle diameter of 5 to 20 μm. When the mean particle diameter is less than 5 μm, an effect of reducing gloss, which is one sake of mixing the urethane resin beads, is poor and many resin beads are required for reducing gloss, and in the case of doing so, a cohesion force of the coating film is decreased and reduction in adhesion property due to agglomeration fracture may occur. When the mean particle diameter is more than 25 μm, the smoothness of the coating film is deteriorated, and the soft feeling may be deteriorated due to reduction in a dry feeling.

The species of the above-mentioned urethane resin beads is not limited to any one of colored beads, colorless beads, transparent beads and opaque beads, and any species of these beads can be used in conformity with aimed design. Examples of commercially available articles of urethane resin beads, which can be used, include ART PEARL C800 Transparent, ART PEARL U-600T, ART PEARL C400 Transparent, ART PEARL P800T (trade names; all produced by Negami Chemical Industrial Co., Ltd.).

A mixing ratio of the particle (D) to the total weight of the resin (A), resin (B) and resin (C) {(D)/[(A)+(B)+(C)]} is preferably 20/100 to 100/100 in terms of the solid weight ratio. When this mixing ratio is less than 20/100, the soft feeling and abrasion resistance of a coating film to be obtained may be deteriorated, and when the mixing ratio is more than 100/100, the adhesion property of a coating film to be obtained to a substrate may be poor.

The water-borne coating composition of the present invention may be a color coating composition or a clear coating composition. When it is the color coating composition, various pigments such as a color pigment, a bright pigment and an extender pigment can be mixed. Examples of the color pigment include organic pigments such as azo lake pigments, insoluble azo pigments, condensation azo pigments, phthalocyanine pigments, indigo pigments, perylnone pigments, perylene pigments, phthalone pigments, dioxazine pigments, quinacridone pigments, isoindolinone pigment, benzoimidazolone pigments, diketopyrrolopyrrole pigments and metal complex pigments, and inorganic pigments such as yellow iron oxide, iron oxide red, carbon black and titanium dioxide. Examples of the above-mentioned bright pigment include flake pigment consisting of cholesteric liquid crystal polymer, aluminum flake pigment, alumina flake pigment coated with metal oxide, silica flake pigment coated with metal oxide, graphite pigment, interference mica pigment, color mica pigment, metal titanium flake pigment, stainless flake pigment, plate iron oxide pigment, metal-plated glass flake pigment, glass flake pigment coated and plated with metal oxide, and hologram pigment. Examples of the extender pigment include barium sulfate, talc, kaoline, and silicates. The pigments can be generally used in a state of being dispersed in a water-borne coating composition as pigment paste. The pigment paste can be generally prepared by adding a pigment and a resin to a solvent and dispersing them in the solvent. And, commercially available pigment paste can also be used. The above-mentioned resin is not particularly limited and include, and examples of the resin include water-soluble resins such as acrylic polyol, polyester polyol and polyacrylic acid. The above-mentioned solvent is not particularly limited, and examples of the solvent include organic solvents such as xylene, and water. For dispersing a resin, equipment such as a sand grinder mill is generally used.

The water-borne coating composition of the present invention may contain other substances to be mixed as required within the range which do not impair the effects of the present invention. Substances to be mixed, which the water-borne coating composition of the present invention can contain, is not particularly limited, and for example, resins other than the (A), (B), and (C), a leveling agent, an anti-settling agent, a matting agent, an ultraviolet absorber, a light stabilizer, an antioxidant, wax, a film formation aid, a crosslinking agent, a thickener, and an antifoaming agent may be added.

The water-borne coating composition of the present invention can also be obtained by stirring and mixing the resins (A), (B) and (C), and the particle (D), and other components as required in order, or can be obtained by adding a particle (D) dispersion prepared by dispersing the above particle (D) in another component as required to a water-borne dispersion prepared by mixing the above (A), (B), and (C).

The water-borne coating composition of the present invention can be used for various plastic substrates and molded articles thereof, and it can be suitably used for plastic substrates such as polyolefins like polypropylene, an ABS resin and polycarbonate, and molded articles thereof, and it can be particularly suitably used for polyolefin substrates such as polypropylene and molded articles thereof.

When coating is carried out using the water-borne coating composition of the present invention, it is not necessary to apply a primer onto a substrate prior to coating, and after generally wiping the substrate clean with alcohol or the like, the water-borne coating composition of the present invention can be applied directly onto a substrate and baked to dry. Further, it is also possible to apply the water-borne coating composition of the present invention onto a substrate coated with a primer.

A method of applying the water-borne coating composition of the present invention to the above-mentioned substrate is not particularly limited, and examples of the method include spray coating, roll coating, bell coating, disk coating, curtain coating, shower coating, spin coating and brush coating, and it is ordinarily possible to coat so as to have a dried film thickness of 10 to 50 μm. The coating composition may be set by leaving it at rest at normal temperature (room temperature) for appropriate time between the above-mentioned applying and the above-mentioned baking to dry.

The above-mentioned baking to dry is preferably implemented by heating. And, even when baking to dry is carried out by the above-mentioned heating, baking to dry can be carried out by heating at low temperatures since it is not necessary to initiate a curing reaction and it is only necessary that the surface of a resin is melted and the resin adheres to a substrate. This heating may be performed, for example, at a temperature of 50° C. or higher for 5 to 60 minutes.

### EFFECT OF THE INVENTION

Since the water-borne coating composition for automotive interior substrates of the present invention has the above-mentioned constitution, it can be applied onto a plastic substrate and baked to dry at low temperatures, and can attain a coating film which is superior in all properties including the adhesion property, the soft feeling, the beef tallow resistance and the abrasion resistance and in addition other performance.

### BRIEF DESCRIPTIONS OF THE DRAWINGS

FIG. 1 is a schematic view showing a measuring method of a melting point of resin, and

FIG. 2 is a schematic view showing a measuring method of a glass transition temperature (Tg) of resin.

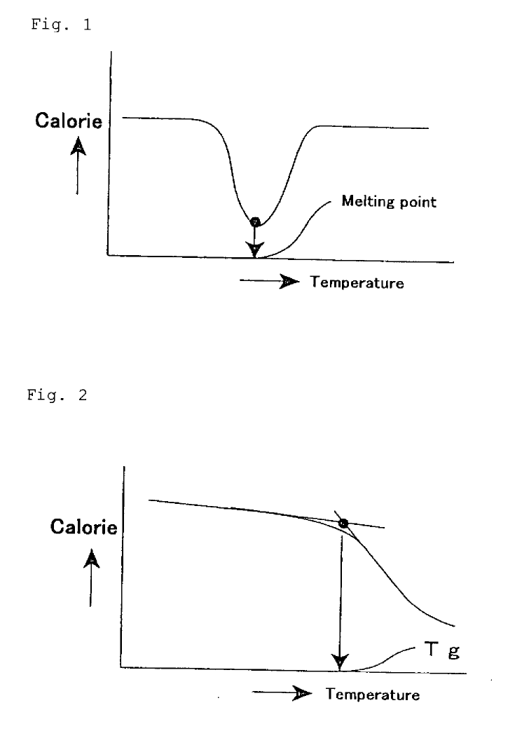

### BEST MODE FOR CARRYING OUT THE INVENTION

Hereinafter, the present invention will be described in more detail by way of examples, but the present invention is not limited to these examples. In addition, “part(s)” and “%” refer to “part(s) by weight” and “% by weight” in Examples, unless otherwise specified.

### Production Example 1 Production of Water-Borne Chlorinated Polyolefin Modified Acrylic Resin POAc-1

To a reaction apparatus equipped with a stirring blade, a thermometer, a dropping equipment, a temperature control unit and a cooler, 25 parts of a polyolefin resin Hardlen 14LWP (produced by Toyo Kasei Kogyo Co., Ltd., solid content 100%, chlorine content 27%, weight average molecular weight 60000), 66.0 parts of methyl methacrylate, 4.5 parts of 2-hydroxyethyl methacrylate, 19.5 parts of isobutyl methacrylate, 20 parts of EMULGEN 920 (produced by KAO Corporation, nonionic surfactant, solid content 100%) and 30 parts of toluene were charged one by one, and the resulting mixture was gradually heated to 100° C. and stirred for 30 minutes to form an uniform solution. Next, a temperature of an internal solution was cooled to 50° C., and then a solution formed by dissolving 1.5 parts of azobis (isobutyronitrile) in 10 parts of methyl methacrylate was added dropwise to the reaction vessel while stirring. Subsequently, 350 parts of deionized water was added dropwise to the content of the reaction vessel over 30 minutes while stirring the content at a rotational speed of 1000 rpm to form an emulsion. This emulsion was heated to 85° C. while stirring the emulsion at a rotational speed of 150 rpm and reacted for 3 hours.

Next, after cooling, toluene was removed from the content under reduced pressure and a small amount of deionized water was added for adjustment to obtain a water-borne chlorinated polyolefin modified acrylic resin POAc-1 having a solid content of 30% and a mean particle diameter of 0.36 μm.

In addition, as samples for measuring a glass transition temperature of an acrylic segment, resins obtained by performing polymerization using the composition and procedure excluding only polyolefin in Table and drying the obtained water-borne acrylic resin were used. Values measured by the above-mentioned differential thermal analyzer are shown in Table 1.

### Production Example 2 Production of Water-Borne Chlorinated Polyolefin Modified Acrylic Resins POAc-2 and POAc-3

POAc-2 and POAc-3 were prepared using the composition shown in Table 1 as with the above-mentioned production of POAc-1. And, the respective water-borne resins' properties are shown in Table 1.

### Production Example 3 Production of Polypropylene Resin PO-1

Into a 1000 ml round bottom flask, 110 ml of deionized water, 22.2 g of magnesium sulfate heptahydrate and 18.2 g of sulfuric acid were put, and the resulting mixture was dissolved while stirring to form a solution. 16.7 g of commercially available granulated montmorillonite was dispersed in the resulting solution, and the resulting dispersion was heated to 100° C. and stirred for two hours. Thereafter, the dispersion was cooled to room temperature to obtain slurry. The obtained slurry was filtrated to recover wet cake. The recovered wet cake was formed into slurry again in the 1000 ml round bottom flask using 500 ml of deionized water and the obtained slurry was filtrated. This operational procedure was repeated twice. Ultimately obtained cake was dried at 110° C. overnight in an atmosphere of nitrogen to obtain 13.3 g of chemically treated montmorillonite.

To 4.4 g of the resulting chemically treated montmorillonite, 20 ml of a toluene solution (0.4 mmol/ml) of triethylaluminum was added, and the resulting mixture was stirred at room temperature for 1 hour. To the resulting suspension, 80 ml of toluene was added, and after stirring the mixture, a supernatant was removed. This operational procedure was repeated twice, and then toluene was added to obtain clay slurry (a slurry concentration was 99 mg clay/ml).

0.2 mmol of triisobutylaluminum was put into another flask, and to this, 19 ml of the obtained clay slurry and a toluene diluent of 131 mg (57 μmol) of dichloro[dimethylsilylene(cyclopentadienyl)-(2,4-dimethyl-4H-5,6,7,8-tetrahydro-1-azulenyl)]hafnium were added, and the resulting mixture was stirred at room temperature for 10 minutes to obtain a catalyst slurry.

Next, into an autoclave of induced mixing type with an internal volume of 24 litters, 11 L of toluene, 3.5 mmol of triisobutylaluminum, 2.48 L of liquid propylene and 0.16 L of liquid ethylene were introduced. All of the above-mentioned catalyst slurry was introduced at room temperature, and the content was heated to 50° C. and continuously stirred at this temperature for 2 hours while maintaining the total pressure at 0.5 MPa and the hydrogen concentration at 400 ppm during polymerization. After the completion of stirring, unreacted propylene was purged from the autoclave to terminate the polymerization. The autoclave was opened to recover all of a toluene solution of polymer. The solvent and a clay residue were removed from the toluene solution to obtain 11 kg of a toluene solution of 18% by weight of ethylene-propylene copolymer (1.98 kg of ethylene-propylene copolymer). The obtained ethylene-propylene copolymer had a weight average molecular weight Mw of 300000 (polystyrene equivalent value) and crystallinity of a polypropylene (PP) segment of 40%.

### Production Example 4 Production of Polypropylene Resins from PO-2 to PO-7

Polypropylene resins from PO-2 to PO-7 were produced by following the same procedure as in Production Example 3 except for changing the polymerization conditions to those shown in Table 2.

### Production Example 5 Production of Maleic Anhydride Modified Polypropylene POM-1

Into a glass flask equipped with a reflux cooler, a thermometer, and a stirrer, 400 g of the ethylene-propylene copolymer (PO-1) obtained in Production Example 3 and 600 g of toluene were put, and the gas phase in the flask was replaced with a nitrogen gas and the content of flask was heated to 110° C. After heating, 100 g of maleic anhydride was added and 30 g of t-butyl peroxy isopropyl monocarbonate (produced by NOF CORPORATION, PERBUTYL I (PBI)) was added, and the resulting mixture was continuously stirred at this temperature for 7 hours to perform a reaction. After the completion of the reaction, a system was cooled to near room temperature, and acetone was added to a reactant to precipitate a polymer, and the precipitated polymer was separated by filtration. Further, precipitation and separation by filtration were repeated using acetone, and an ultimately obtained polymer was cleaned with acetone. White powdery maleic anhydride modified polymer POM-1 was obtained by drying a polymer obtained by cleaning under reduced pressure. The infrared absorption spectrum of this modified polymer was measured, and consequently the content (degree of grafting) of a maleic anhydride group was 3.6% by weight (0.36 mmol/g). And, a weight average molecular weight was 100000.

### Production Example 6 Production of Maleic Anhydride Modified Polypropylenes from POM-2 to POM-9

Maleic anhydride modified polypropylenes from POM-2 to POM-9 were produced by following the same procedure as in Production Example 5 except for changing polypropylene resins to be used and the composition to those shown in Table 3.

### Production Example 7 Production of Water-Borne Maleic Anhydride Modified Polypropylene POMW-1

To a reaction apparatus equipped with a stirring blade, a thermometer, a dropping equipment, a temperature control unit and a cooler, 100 g of POM-1 prepared in Production Example 5 and 200 g of toluene were added, and the resulting mixture was heated to 100° C. to be dissolved, and cooled to 70° C. Thereafter, 15 g of a nonionic surfactant EMULGEN 220 (produced by KAO Corporation, HLB 14.2, solid content 100%) and 15 g of a nonionic surfactant EMULGEN 147 (produced by KAO Corporation, HLB 16.3, solid content 100%) were added and dissolved, and cooled to 50° C. 520 g of deionized water was gradually added while keeping the temperature at 50° C. to emulsify the content through phase inversion.

Then, the content was cooled to room temperature, and to this, 2-amino-2-methyl-1-propanol was added to adjust to a pH of 8. Then, toluene was removed from the content under reduced pressure and a small amount of deionized water was added for adjustment to obtain a water dispersion of polypropylene having a solid content of 20%. A mean particle diameter of the water dispersion of polypropylene was 0.32 μm.

### Production Example 8 Production of Water-Borne Maleic Anhydride Modified Polypropylenes from POMW-2 to POMW-9

Water-borne maleic anhydride modified polypropylenes from POMW-2 to POMW-9 were produced by following the same procedure as in Production Example 7 except for changing the amounts to be mixed to those shown in Table 4.

### Example 1 Production of Water-Borne Coating Composition

125.0 g (solid content 40%) of ADEKA BONTIGHTER HUX-561 (produced by ADEKA Corporation), 66.7 g (solid content 30%) of water-borne chlorinated polyolefin modified acrylic resin (the POAc-1), and 150 g (solid content 20%) of water-borne maleic anhydride modified polypropylene (the POMW-1) were charged into a container one by one while stirring a mixture, and the resulting mixture was stirred uniformly. Next, 5.0 g (solid content 100%) of POLYFLOW KL245 (produced by Kyoeisha Chemical Co., Ltd.), 5.0 g (solid content 100%) of MPP 620VF (produced by Micropowders Inc.), and 30.0 g of butyl cellosolve were added, and the resulting mixture was stirred. Further, 40.0 g of ART PEARL C800 Transparent (produced by Negami Chemical Industrial Co., Ltd., mean particle diameter 6 μm) was added little by little, and then the resulting mixture was stirred for 30 minutes to be dispersed uniformly. 25.3 g (solid content 40.4%, PWC 75.7%) of FCW black 420 pigment paste (produced by Nippon Paint Co., Ltd.) was added, and 10.7 g (solid content 28.0%) of PRIMAL ASE-60 (produced by Rohm and Haas Company) and 8.7 g of deionized water were added to obtain a water-borne coating composition. The solid content of the coating composition was 35%.

### Examples 2 to 12 and Comparative Examples 1 to 8 Production of Water-Borne Coating Compositions

Water-borne coating compositions were produced by following the same procedure as in Example 1 except for changing the amounts to be mixed to those shown in Tables 5 and 6. However, in Example 2, as the elastic particle (D), ART PEARL C400 Transparent (mean particle diameter 14 μm, produced by Negami Chemical Industrial Co., Ltd.) was used.

[Preparation of Test Piece]

<Coating Method>

The obtained water-borne coating composition was applied by spray to a polypropylene substrate having a size of 150 mm×70 mm×3 mm, and the water-borne coating composition was left standing at room temperature for five minutes and baked at 60° C. for 20 minutes to obtain a test piece of 25 μm in a dried film thickness. The obtained test piece was evaluated according to the following criteria. The results of evaluations are shown in Tables 7 and 8. Further, values of the elongation percentage of a resin were measurement by the method described above.

And, the crystallinity (stereoregularity), the weight average molecular weights, and Tg described in Table are measured by the methods described above. Further, mean particle diameters of the emulsion particles are values measured by a laser light diffraction particle diameter analyzer (Microtrac UPA: produced by NIKKISO CO., LTD.)

(Degree of Grafting)

200 mg of a polymer and 4800 mg of chloroform were put into a 10 ml sample bottle and completely dissolved by heating at 50° C. for 30 minutes. Chloroform was put in a liquid cell, made of NaCl, with an optical path length of 0.5 mm and this cell was used as a back ground. Next, the melted polymer solution was put in the cell and infrared absorption spectrum was measured at number of integrations of 32 using FT-IR 460 plus manufactured by JASCO Corporation. The degree of grafting of maleic anhydride was calculated by use of a calibration curve made by measuring a solution prepared by dissolving maleic anhydride in chloroform. And, the content of acid components in a polymer was determined using a calibration curve made previously based on an area of an absorption peak (a maximum peak near 1780 cm⁻¹, 1750 to 1813 cm⁻¹) of a carbonyl group, and this content is assumed to be a degree of grafting (by weight)

(Evaluation of Coating Film Performance)

<Adhesion Property>

Longitudinal and lateral slits of 2 mm in width were cut on a coating film with a cutter knife and 100 lattices were formed, and an adhesive tape was stuck thereon, and one end of the tape was pulled up to peel the tape. This peeling motion was repeated three times at one point. Number of lattices in which a coating film within a lattice was peeled by 50% or more of an area of a lattice was evaluated. When number of lattices peeled is 0, the coating film is rated as good (◯), and when this number of lattices is 1 or more, the coating film is rated as bad (X).

<Beef Tallow Resistance>

2 g/100 cm² of beef tallow (reagent) is applied onto the surface of the test piece and spread uniformly. Relatively small cloth (flannel) was placed on the test piece, and this is placed in an electric oven without forced-circulation, in which ambient temperature is set at 80° C., and left standing for 1 week.

The test piece is taken out after prescribed time and washed with water so that an adhesive tape adheres to it well.

A test of fastness to rubbing by a rubdown and an adhesion test by a cross cut method are performed, and “No peeling of a coating film” and “No exposure of a substrate” on the rubbing test, and “No peeling” on the adhesion test are rated as good (◯), and when any one of these conditions is not good, it is rated as bad (X).

Incidentally, a length of a cut portion is 2 cm in the adhesion test by a cross cut method, and the test conditions of fastness to rubbing by a rubdown are as follows.

Dry cloth: gauze (pharmaceutical codex), five-layered gauze

Load of a rubbing element: 49.04 kPa (500 gf/cm²)

Stroke of a rubbing element: 100 mm

Number of rubbings: 200 to-and-fro movements

<Abrasion Resistance>

A rubbing test was performed under the conditions of load 2 kg/cm², five-layered gauze on a rubbing element, number of rubbings 20 to-and-fro movements, rubbing speed 30 to-and-fro movements/min

◯: There is no significant abrasion, fading and exposure of a substrate.

X: There are significant abrasions, fadings and exposures of a substrate.

Evaluation of Touch Feeling (Soft Feeling)

<Wet Feeling>

Feeling in touching the sample with fingers was evaluated according to the following criteria.

◯: There is a moderate wet feeling in touching the test piece with hand.

X: There is not a moderate wet feeling in touching the test piece with hand, and there is a tacky feel.

<Dry Feeling>

Feeling in touching the sample with fingers was evaluated according to the following criteria.

◯: There is a moderate dry feeling in touching the test piece with hand.

X: There is not a moderate dry feeling in touching the test piece with hand.

TABLE 1

| | | POAc-1 | POAc-2 | POAc-3 |
|---|---|---|---|---|
| Amount to | Hardlen 14LWP (part) | 25.0 | 25.0 | 25.0 |
| be mixed | Toluene (part) | 30.0 | 30.0 | 30.0 |
| | Methyl methacrylate | 66.0 | 13.5 | 53.0 |
| | (charged amount) (part) | | | |
| | 2-hydroxyethyl (meth)acrylate | 4.5 | 4.5 | 4.5 |
| | (part) | | | |
| | Isobutyl (meth)acrylate (part) | 19.5 | 72.0 | 0.0 |
| | EMULGEN 920 surfactant (part) | 20 | 20 | 20 |
| | Azobis(isobutyronitrile) (part) | 1.5 | 1.5 | 1.5 |
| | Methyl methacrylate | 10.0 | 10.0 | 10.0 |
| | (amount to be added dropwise) | | | |
| | (part) | | | |
| | Isoboronyl methacrylate (part) | 0 | 0 | 32.5 |
| | Deionized water (part) | 350 | 350 | 350 |
| Resin | Solid content (%) | 30 | 30 | 30 |
| properties | Mean particle diameter (μm) | 0.36 | 0.28 | 0.35 |
| | Glass transition temperature | 90 | 60 | 110 |
| | of acrylic segment (° C.) | | | |
| | Ratio of PO to acrylic | 20/80 | 20/80 | 20/80 |

TABLE 2

| | | | | | Mw on the | | |
|---|---|---|---|---|---|---|---|
| | | | | [E (ethylene | polystyrene | | [PP |
| | | Pressure | [ETY (ethylene charge | addition | equivalent | Crystallinity | (polypropylene)] |
| Product name | temp./(° C.) | (MPa) | amount)] G/% | amount)] mol % | basis | (%) | content (wt %) |
| Production Example PO-1 | 50 | 0.5 | 6 | 3 | 300000 | 40 | 18 |
| Production Example PO-2 | 75 | 0.7 | — | — | 80000 | 36 | 7.3 |
| Production Example PO-3 | 90 | 0.75 | — | — | 150000 | 33 | 9.4 |
| Production Example PO-4 | 60 | 0.65 | — | — | 330000 | 51 | 7.9 |
| Production Example PO-5 | 62 | 0.65 | — | — | 300000 | 48 | 11 |
| Production Example PO-6 | 67 | 0.65 | — | — | 270000 | 46 | 10.9 |
| Production Example PO-7 | 69 | 0.65 | — | — | 80000 | 41 | 12.5 |

TABLE 3

| | | | | | | | | Mw on the polystyrene | Melting |
|---|---|---|---|---|---|---|---|---|---|
| | Name of | PP | | Maleic | | Degree of | | equivalent basis | point |
| Product name | substance used | PO-1 to PO-7 | Toluene | anhydride | PBI | grafting | Crystallinity (%) | POM-1 to POM-9 | (° C.) |
| Production Example | Production | 400 | 600 | 100 | 30 | 3.6 | 40 | 100000 | 60 |
| POM-1 | Example PO-1 | | | | | | | | |
| Production Example | Production | 600 | 400 | 18 | 9 | 1.2 | 36 | 70000 | 60 |
| POM-2 | Example PO-2 | | | | | | | | |
| Production Example | Production | 350 | 650 | 105 | 35 | 4.1 | 48 | 100000 | 75 |
| POM-3 | Example PO-5 | | | | | | | | |
| Production Example | Production | 600 | 400 | 18 | 9 | 1.2 | 41 | 60000 | 70 |
| POM-4 | Example PO-7 | | | | | | | | |
| Production Example | Production | 400 | 600 | 20 | 10 | 1.2 | 40 | 180000 | 60 |
| POM-5 | Example PO-1 | | | | | | | | |
| Production Example | Production | 600 | 400 | 30 | 15 | 1.6 | 33 | 110000 | —*¹⁾ |
| POM-6 | Example PO-3 | | | | | | | | |
| Production Example | Production | 350 | 650 | 17.5 | 8.75 | 1.2 | 51 | 160000 | 80 |
| POM-7 | Example PO-4 | | | | | | | | |
| Production Example | Production | 400 | 600 | 30 | 10 | 4 | 36 | 30000 | 60 |
| POM-8 | Example PO-2 | | | | | | | | |
| Production Example | Production | 400 | 600 | 2 | 1 | 0.1 | 40 | 250000 | 60 |
| POM-9 | Example PO-1 | | | | | | | | |

*¹⁾No melting point because of amorphous

TABLE 4

| | | | | | | | | Nonvolatile |
|---|---|---|---|---|---|---|---|---|
| | Name of POM | POM1 to POM9 | | | | Deionized | Particle | matter |
| Product name | used | (solid content 100%) | EMULGEN 220 | EMULGEN 147 | Toluene | water | diameter | (% by weight) |
| Production | Production | 100 | 15 | 15 | 200 | 520 | 0.32 μ | 20 |
| Example | Example POM-1 | | | | | | | |
| POMW-1 | | | | | | | | |
| Production | Production | 100 | 15 | 15 | 150 | 520 | 0.18 μ | 20 |
| Example | Example POM-2 | | | | | | | |
| POMW-2 | | | | | | | | |
| Production | Production | 100 | 15 | 15 | 250 | 520 | 0.36 μ | 20 |
| Example | Example POM-3 | | | | | | | |
| POMW-3 | | | | | | | | |
| Production | Production | 100 | 15 | 15 | 200 | 520 | 0.21 μ | 20 |
| Example | Example POM-4 | | | | | | | |
| POMW-4 | | | | | | | | |
| Production | Production | 100 | 15 | 15 | 250 | 520 | 0.30 μ | 20 |
| Example | Example POM-5 | | | | | | | |
| POMW-5 | | | | | | | | |
| Production | Production | 100 | 15 | 15 | 150 | 520 | 0.20 μ | 20 |
| Example | Example POM-6 | | | | | | | |
| POMW-6 | | | | | | | | |
| Production | Production | 100 | 15 | 15 | 300 | 520 | 0.42 μ | 20 |
| Example | Example POM-7 | | | | | | | |
| POMW-7 | | | | | | | | |
| Production | Production | 100 | 15 | 15 | 100 | 520 | 0.39 μ | 20 |
| Example | Example POM-8 | | | | | | | |
| POMW-8 | | | | | | | | |
| Production | Production | 100 | 15 | 15 | 300 | 520 | could not | — |
| Example | Example POM-9 | | | | | | emulsify | |
| POMW-9 | | | | | | | | |

TABLE 5

| | Example 1 | | Example 2 | | Example 3 | | Example 4 | | Example 5 | | Example 6 | |
|---|---|---|---|---|---|---|---|---|---|---|---|---|
| Water-borne urethane | ADEKA | | ADEKA | | ADEKA | | ADEKA | | ADEKA | | ADEKA | |
| resin (A) | BONTIGHTER | | BONTIGHTER | | BONTIGHTER | | BONTIGHTER | | BONTIGHTER | | BONTIGHTER | |
| | HUX-561 | | HUX-561 | | HUX-561 | | HUX-561 | | HUX-561 | | HUX-561 | |
| Olefin modified | POAc-1 | | POAc-1 | | POAc-1 | | POAc-1 | | POAc-1 | | POAc-1 | |
| acrylic resin (B) | | | | | | | | | | | | |
| Water-borne | POMW-1 | | POMW-2 | | POMW-3 | | POMW-4 | | POMW-5 | | POMW-1 | |
| polyolefin resin (C) | | | | | | | | | | | | |
| Elastic particle (D) | ART PEARL | | ART PEARL | | ART PEARL | | ART PEARL | | ART PEARL | | ART PEARL | |
| | C800 | | C400 | | C800 | | C800 | | C800 | | C800 | |
| | Transparent | | Transparent | | Transparent | | Transparent | | Transparent | | Transparent | |
| | Solid | Amount | Solid | Amount | Solid | Amount | Solid | Amount | Solid | Amount | Solid | Amount |
| | con- | to be | con- | to be | con- | to be | con- | to be | con- | to be | con- | to be |
| | tent | mixed | tent | mixed | tent | mixed | tent | mixed | tent | mixed | tent | mixed |
| Water-borne | 50.0 | 125.0 | 50.0 | 125.0 | 50.0 | 125.0 | 50.0 | 125.0 | 50.0 | 125.0 | 60.0 | 150.0 |
| urethane resin (A) | | | | | | | | | | | | |
| Olefin modified | 20.0 | 66.7 | 20.0 | 66.7 | 20.0 | 66.7 | 20.0 | 66.7 | 20.0 | 66.7 | 20.0 | 66.7 |
| acrylic resin (B) | | | | | | | | | | | | |
| Water-borne | 30.0 | 150 | 30.0 | 150 | 30.0 | 150 | 30.0 | 150 | 30.0 | 150 | 30.0 | 150 |
| polyolefin resin (C) | | | | | | | | | | | | |
| Elastic particle (D) | 40.0 | 40.0 | 40.0 | 40.0 | 40.0 | 40.0 | 40.0 | 40.0 | 40.0 | 40.0 | 40.0 | 40.0 |
| POLYFLOW KL245 | 5.0 | 5.0 | 5.0 | 5.0 | 5.0 | 5.0 | 5.0 | 5.0 | 5.0 | 5.0 | 5.0 | 5.0 |
| MPP 620VF | 5.0 | 5.0 | 5.0 | 5.0 | 5.0 | 5.0 | 5.0 | 5.0 | 5.0 | 5.0 | 5.0 | 5.0 |
| Butyl cellosolve | 0.0 | 30.0 | 0.0 | 30.0 | 0.0 | 30.0 | 0.0 | 30.0 | 0.0 | 30.0 | 0.0 | 30.0 |
| FCW 420 pigment paste | 10.2 | 25.3 | 10.2 | 25.3 | 10.2 | 25.3 | 10.2 | 25.3 | 10.2 | 25.3 | 10.2 | 25.3 |
| ASE-60 | 3.0 | 10.7 | 3.0 | 10.7 | 3.0 | 10.7 | 3.0 | 10.7 | 3.0 | 10.7 | 3.0 | 10.7 |
| Deionized water | 0 | 8.7 | 0 | 8.7 | 0 | 8.7 | 0 | 8.7 | 0 | 8.7 | 0 | 33.7 |
| Total | 163.2 | 466.3 | 163.2 | 466.3 | 163.2 | 466.3 | 163.2 | 466.3 | 163.2 | 466.3 | 173.2 | 516.4 |
| Solid content (%) | 35.0 | | 35.0 | | 35.0 | | 35.0 | | 35.0 | | 33.5 | |
| | Example 7 | | Example 8 | | Example 9 | | Example 10 | | Example 11 | | Example 12 | |
| Water-borne | ADEKA | | ADEKA | | ADEKA | | ADEKA | | ADEKA | | ADEKA | |
| urethane resin (A) | BONTIGHTER | | BONTIGHTER | | BONTIGHTER | | BONTIGHTER | | BONTIGHTER | | BONTIGHTER | |
| | HUX-561 | | HUX-561 | | HUX-561 | | HUX-561 | | HUX-561 | | HUX-561 | |
| Olefin modified | POAc-1 | | POAc-1 | | POAc-1 | | POAc-1 | | POAc-2 | | POAc-3 | |
| acrylic resin (B) | | | | | | | | | | | | |
| Water-borne | POMW-1 | | POMW-2 | | POMW-3 | | POMW-4 | | POMW-5 | | POMW-1 | |
| polyolefin resin (C) | | | | | | | | | | | | |
| Elastic particle (D) | ART PEARL | | ART PEARL | | ART PEARL | | ART PEARL | | ART PEARL | | ART PEARL | |
| | C800 | | C800 | | C800 | | C800 | | C800 | | C800 | |
| | Transparent | | Transparent | | Transparent | | Transparent | | Transparent | | Transparent | |
| | Solid | Amount | Solid | Amount | Solid | Amount | Solid | Amount | Solid | Amount | Solid | Amount |
| | con- | to be | con- | to be | con- | to be | con- | to be | con- | to be | con- | to be |
| | tent | mixed | tent | mixed | tent | mixed | tent | mixed | tent | mixed | tent | mixed |
| Water-borne | 35.0 | 87.5 | 60.0 | 150.0 | 50.0 | 125.0 | 50.0 | 125.0 | 50.0 | 125.0 | 50.0 | 125.0 |
| urethane resin (A) | | | | | | | | | | | | |
| Olefin modified | 20.0 | 66.7 | 10.0 | 33.3 | 20.0 | 66.7 | 20.0 | 66.7 | 20.0 | 66.7 | 20.0 | 66.7 |
| acrylic resin (B) | | | | | | | | | | | | |
| Water-borne | 45.0 | 225 | 30.0 | 150 | 30.0 | 150 | 30.0 | 150 | 30.0 | 150 | 30.0 | 150 |
| polyolefin resin (C) | | | | | | | | | | | | |
| Elastic particle (D) | 40.0 | 40.0 | 40.0 | 40.0 | 30.0 | 30.0 | 90.0 | 90.0 | 54.0 | 54.0 | 54.0 | 54.0 |
| POLYFLOW KL245 | 5.0 | 5.0 | 5.0 | 5.0 | 5.0 | 5.0 | 5.0 | 5.0 | 5.0 | 5.0 | 5.0 | 5.0 |
| MPP 620VF | 5.0 | 5.0 | 5.0 | 5.0 | 5.0 | 5.0 | 5.0 | 5.0 | 5.0 | 5.0 | 5.0 | 5.0 |
| Butyl cellosolve | 0.0 | 30.0 | 0.0 | 30.0 | 0.0 | 30.0 | 0.0 | 30.0 | 0.0 | 30.0 | 0.0 | 30.0 |
| FCW 420 pigment paste | 10.2 | 25.3 | 10.2 | 25.3 | 10.2 | 25.3 | 10.2 | 25.3 | 10.2 | 25.3 | 10.2 | 25.3 |
| ASE-60 | 3.0 | 10.7 | 3.0 | 10.7 | 3.0 | 10.7 | 3.0 | 10.7 | 3.0 | 10.7 | 3.0 | 10.7 |
| Deionized water | 0 | 0 | 0 | 17.0 | 0 | 0 | 0 | 101.5 | 0 | 34.7 | 0 | 34.7 |
| Total | 163.2 | 495.1 | 163.2 | 466.3 | 153.2 | 447.6 | 213.2 | 609.2 | 177.2 | 506.3 | 177.2 | 506.3 |

| | | | | | | |
|---|---|---|---|---|---|---|
| Solid content (%) | 33.0 | 35.0 | 34.2 | 35.0 | 35.0 | 35.0 |

TABLE 6

| | Compar. Ex. 1 | | Compar. Ex. 2 | | Compar. Ex. 3 | | Compar. Ex. 4 | |
|---|---|---|---|---|---|---|---|---|
| Water-borne urethane resin (A) | ADEKA BONTIGHTER | | ADEKA BONTIGHTER | | ADEKA BONTIGHTER | | ADEKA BONTIGHTER | |
| | HUX-561 | | HUX-561 | | HUX-561 | | HUX-561 | |
| Olefin modified acrylic resin (B) | POAc-1 | | POAc-1 | | POAc-1 | | POAc-1 | |
| Water-borne polyolefin resin (C) | POMW-6 | | POMW-7 | | POMW-8 | | POMW-9 | |
| Elastic particle (D) | ART PEARL C800 | | ART PEARL C800 | | ART PEARL C800 | | ART PEARL C800 | |
| | Transparent | | Transparent | | Transparent | | Transparent | |
| | Solid | Amount to | Solid | Amount to | Solid | Amount to | Solid | Amount to |
| | content | be mixed | content | be mixed | content | be mixed | content | be mixed |
| Water-borne urethane resin (A) | 50.0 | 125.0 | 50.0 | 125.0 | 50.0 | 125.0 | 50.0 | 125.0 |
| Olefin modified acrylic resin (B) | 20.0 | 66.7 | 20.0 | 66.7 | 20.0 | 66.7 | 20.0 | 66.7 |
| Water-borne polyolefin resin (C) | 30.0 | 150 | 30.0 | 150 | 30.0 | 150 | 30.0 | 150 |
| Elastic particle (D) | 40.0 | 40.0 | 40.0 | 40.0 | 40.0 | 40.0 | 40.0 | 40.0 |
| POLYFLOW KL245 | 5.0 | 5.0 | 5.0 | 5.0 | 5.0 | 5.0 | 5.0 | 5.0 |
| MPP 620VF | 5.0 | 5.0 | 5.0 | 5.0 | 5.0 | 5.0 | 5.0 | 5.0 |
| Butyl cellosolve | 0.0 | 30.0 | 0.0 | 30.0 | 0.0 | 30.0 | 0.0 | 30.0 |
| FCW 420 pigment paste | 10.2 | 25.3 | 10.2 | 25.3 | 10.2 | 25.3 | 10.2 | 25.3 |
| ASE-60 | 3.0 | 10.7 | 3.0 | 10.7 | 3.0 | 10.7 | 3.0 | 10.7 |
| Deionized water | 0 | 8.7 | 0 | 8.7 | 0 | 8.7 | 0 | 8.7 |
| Total | 163.2 | 466.3 | 163.2 | 466.3 | 163.2 | 466.3 | 163.2 | 466.3 |
| Solid content (%) | 35.0 | | 35.0 | | 35.0 | | 35.0 | |
| | Compar. Ex. 5 | | Compar. Ex. 6 | | Compar. Ex. 7 | | Compar. Ex. 8 | |
| Water-borne urethane resin (A) | ADEKA BONTIGHTER | | ADEKA BONTIGHTER | | ADEKA BONTIGHTER | | ADEKA BONTIGHTER | |
| | HUX-561 | | HUX-561 | | HUX-561 | | HUX-561 | |
| Olefin modified acrylic resin (B) | POAc-1 | | POAc-1 | | POAc-1 | | POAc-1 | |
| Water-borne polyolefin resin (C) | POMW-1 | | POMW-1 | | POMW-1 | | POMW-1 | |
| Elastic particle (D) | ART PEARL C800 | | ART PEARL C800 | | ART PEARL C800 | | ART PEARL C800 | |
| | Transparent | | Transparent | | Transparent | | Transparent | |
| | Solid | Amount to | Solid | Amount to | Solid | Amount to | Solid | Amount to |
| | content | be mixed | content | be mixed | content | be mixed | content | be mixed |
| Water-borne urethane resin (A) | 70.0 | 175.0 | 20.0 | 50.0 | 70.0 | 175.0 | 28.0 | 70.0 |
| Olefin modified acrylic resin (B) | 20.0 | 66.7 | 20.0 | 66.7 | 0.0 | 0 | 42.0 | 140 |
| Water-borne polyolefin resin (C) | 10.0 | 50 | 60.0 | 300 | 30.0 | 150 | 30.0 | 150 |
| Elastic particle (D) | 40.0 | 40.0 | 40.0 | 40.0 | 40.0 | 40.0 | 40.0 | 40.0 |
| POLYFLOW KL245 | 5.0 | 5.0 | 5.0 | 5.0 | 5.0 | 5.0 | 5.0 | 5.0 |
| MPP 620VF | 5.0 | 5.0 | 5.0 | 5.0 | 5.0 | 5.0 | 5.0 | 5.0 |
| Butyl cellosolve | 0.0 | 30.0 | 0.0 | 30.0 | 0.0 | 30.0 | 0.0 | 30.0 |
| FCW 420 pigment paste | 10.2 | 25.3 | 10.2 | 25.3 | 10.2 | 25.3 | 10.2 | 25.3 |
| ASE-60 | 3.0 | 10.7 | 3.0 | 10.7 | 3.0 | 10.7 | 3.0 | 10.7 |
| Deionized water | 0 | 58.7 | 0 | 0 | 0 | 25.3 | 0 | 0 |
| Total | 163.2 | 466.3 | 163.2 | 532.6 | 163.2 | 466.2 | 163.2 | 476.0 |

| | | | | |
|---|---|---|---|---|
| Solid content (%) | 35.0 | 30.6 | 35.0 | 34.3 |

TABLE 7

| | | | Example 1 | Example 2 | Example 3 | Example 4 | Example 5 | Example 6 |
|---|---|---|---|---|---|---|---|---|
| Water-borne polyolefin resin (C) | | | POMW-1 | POMW-2 | POMW-3 | POMW-4 | POMW-5 | POMW-1 |
| | Solid amount to be mixed | | 30 | 30 | 30 | 30 | 30 | 20 |
| | (% by weight) | | | | | | | |
| | Elongation percentage of resin (%) | | 600 | 650 | 600 | 500 | 800 | 600 |
| Water-borne chlorinated polyolefin | | | POAc-1 | POAc-1 | POAc-1 | POAc-1 | POAc-1 | POAc-1 |
| modified acrylic resin (B) | | | | | | | | |
| | Solid amount to be mixed | | 20 | 20 | 20 | 20 | 20 | 20 |
| | (% by weight) | | | | | | | |
| Water-borne urethane resin (A) | | | | | | | | |
| | Solid Amount to be mixed | | 50 | 50 | 50 | 50 | 50 | 60 |
| | (% by weight) | | | | | | | |
| | Elongation percentage of resin (%) | | 300 | 300 | 300 | 300 | 300 | 300 |
| Solid weight ratio (A)/(B) | | | 71/29 | 71/29 | 71/29 | 71/29 | 71/29 | 75/25 |
| Solid weight ratio (D)/[(A) + (B) + (C)] | | | 40 | 40 | 40 | 40 | 40 | 40 |
| Result of | Coating film | Cross cut | ∘ | ∘ | ∘ | ∘ | ∘ | ∘ |
| performance | performance | adhesion | | | | | | |
| | | Beef tallow | ∘ | ∘ | ∘ | ∘ | ∘ | ∘ |
| | | resistance | | | | | | |
| | | Abrasion | ∘ | ∘ | ∘ | ∘ | ∘ | ∘ |
| | | resistance | | | | | | |
| | Soft feeling | Wet feeling | ∘ | ∘ | ∘ | ∘ | ∘ | ∘ |
| | | Dry feeling | ∘ | ∘ | ∘ | ∘ | ∘ | ∘ |
| | | Wet feeling/ | ∘/∘ | ∘/∘ | ∘/∘ | ∘/∘ | ∘/∘ | ∘/∘ |
| | | Dry feeling | | | | | | |

| | | | Example 7 | Example 8 | Example 9 | Example 10 | Example 11 | Example 12 |
|---|---|---|---|---|---|---|---|---|
| Water-borne polyolefin resin (C) | | | POMW-1 | POMW-2 | POMW-3 | POMW-4 | POMW-5 | POMW-1 |
| | Solid amount to be mixed | | 45 | 30 | 30 | 30 | 30 | 30 |
| | (% by weight) | | | | | | | |
| | Elongation percentage of resin (%) | | 600 | 600 | 600 | 600 | 600 | 600 |
| Water-borne chlorinated polyolefin | | | POAc-1 | POAc-1 | POAc-1 | POAc-1 | POAc-2 | POAc-3 |
| modified acrylic resin (B) | | | | | | | | |
| | Solid amount to be mixed | | 20 | 10 | 20 | 20 | 20 | 20 |
| | (% by weight) | | | | | | | |
| Water-borne urethane resin (A) | | | | | | | | |
| | Solid Amount to be mixed | | 35 | 60 | 50 | 50 | 50 | 50 |
| | (% by weight) | | | | | | | |
| | Elongation percentage of resin (%) | | 300 | 300 | 300 | 300 | 300 | 300 |
| Solid weight ratio (A)/(B) | | | 64/36 | 86/14 | 71/29 | 71/29 | 71/29 | 71/29 |
| Solid weight ratio (D)/[(A) + (B) + (C)] | | | 40 | 40 | 30 | 90 | 54 | 54 |
| Result of | Coating film | Cross cut | ∘ | ∘ | ∘ | ∘ | ∘ | ∘ |
| performance | performance | adhesion | | | | | | |
| | | Beef tallow | ∘ | ∘ | ∘ | ∘ | ∘ | ∘ |
| | | resistance | | | | | | |
| | | Abrasion | ∘ | ∘ | ∘ | ∘ | ∘ | ∘ |
| | | resistance | | | | | | |
| | Soft feeling | Wet feeling | ∘ | ∘ | ∘ | ∘ | ∘ | ∘ |
| | | Dry feeling | ∘ | ∘ | ∘ | ∘ | ∘ | ∘ |
| | | Wet feeling/ | ∘/∘ | ∘/∘ | ∘/∘ | ∘/∘ | ∘/∘ | ∘/∘ |
| | | Dry feeling | | | | | | |

TABLE 8

| | | | Compar- | Compar- | Compar- | Compar- | Compar- | Compar- | Compar- | Compar- |
|---|---|---|---|---|---|---|---|---|---|---|
| | | | ative | ative | ative | ative | ative | ative | ative | ative |
| | | | Exam- | Exam- | Exam- | Exam- | Exam- | Exam- | Exam- | Exam- |
| | | | ple 1 | ple 2 | ple 3 | ple 4 | ple 5 | ple 6 | ple 7 | ple 8 |
| Water-borne polyolefin resin (C) | | | POMW-6 | POMW-7 | POMW-8 | POMW-9 | POMW-1 | POMW-1 | POMW-1 | POMW-1 |
| | Solid amount to be mixed | | 30 | 30 | 30 | 30 | 10 | 60 | 30 | 30 |
| | (% by weight) | | | | | | | | | |
| | Elongation percentage of resin (%) | | 700 | 550 | 450 | 900 | 600 | 600 | 600 | 600 |
| Water-borne chlorinated | | | POAc-1 | POAc-1 | POAc-1 | POAc-1 | POAc-1 | POAc-1 | POAc-1 | POAc-1 |
| polyolefin modified | | | | | | | | | | |
| acrylic resin (B) | | | | | | | | | | |
| | Solid amount to be mixed | | 20 | 20 | 20 | 20 | 20 | 20 | 0 | 42 |
| | (% by weight) | | | | | | | | | |
| Water-borne urethane resin (A) | | | | | | | | | | |
| | Solid Amount to be mixed | | 50 | 50 | 50 | 50 | 70 | 20 | 70 | 28 |
| | (% by weight) | | | | | | | | | |
| | Elongation percentage of resin (%) | | 300 | 300 | 300 | 300 | 300 | 300 | 300 | 300 |
| Solid weight ratio (A)/(B) | | | 71/29 | 71/29 | 71/29 | 71/29 | 78/22 | 50/50 | 100/0 | 40/60 |
| Solid weight ratio (D)/[(A) + | | | 40 | 40 | 40 | 40 | 40 | 40 | 40 | 40 |
| (B) + (C)] | | | | | | | | | | |
| Result | Coating | Cross cut | ∘ | x | x | could not | x | ∘ | x | ∘ |
| of | film | adhesion | | | | emulsify | | | | |
| perfor- | perfor- | Beef tallow | x | ∘ | x | resin (c) | ∘ | x | x | ∘ |
| mance | mance | resistance | | | | | | | | |
| | | Abrasion | ∘ | ∘ | ∘ | | ∘ | ∘ | x | ∘ |
| | | resistance | | | | | | | | |
| | Soft | Wet feeling | ∘ | ∘ | ∘ | | ∘ | x | ∘ | x |
| | feeling | Dry feeling | ∘ | ∘ | ∘ | | ∘ | ∘ | ∘ | ∘ |
| | | Wet feeling/ | ∘/∘ | ∘/∘ | ∘/∘ | | ∘/∘ | x/∘ | ∘/∘ | x/∘ |
| | | Dry feeling | | | | | | | | |

From the results of Table 7, it is evident that when the coating compositions obtained in Examples were used, coating films having excellent adhesion property, beef tallow resistance and abrasion resistance could be obtained and a soft feeling was also excellent. On the other hand, it is found from the results of Table 8 that when the coating compositions obtained in Comparative Examples were used, a coating film which is superior in all performance could not be obtained.

### INDUSTRIAL APPLICABILITY

The water-borne coating composition for automotive interior substrates of the present invention can be suitably used for various plastic substrates and molded articles thereof.

1. A water-borne coating composition for automotive interior substrates including a water-borne urethane resin (A), a water-borne chlorinated polyolefin modified acrylic resin (B), a water-borne polyolefin resin (C) and elastic particles (D),
wherein the content of said resin (C) is 15 to 50% by weight when the total weight of said resin (A), resin (B) and resin (C) is taken as 100% by weight,
a solid weight ratio [(A)/(B)] of said resin (A) and resin (B) is 90/10 to 50/50,
said resin (A) has an elongation percentage of 100% or more at 20° C.,
an amount of chlorinated polyolefin modified segment in said resin (B) is 5 to 40% by weight, and
said resin (C) is a water-borne polypropylene resin that is not chlorinated, and has crystallinity of 35 to 50% and a weight average molecular weight of 50000 to 200000.

2. The water-borne coating composition for automotive interior substrates according to claim 1,
wherein the resin (C) is obtained by using a metallocene catalyst.

3. The water-borne coating composition for automotive interior substrates according to claim 1 or 2, wherein the resin (C) has an elongation percentage of 400% or more at 20° C.

4. The water-borne coating composition for automotive interior substrates according to claim 1 or 2,
wherein the resin (C) is modified with an unsaturated organic acid or acid anhydride thereof.

5. The water-borne coating composition for automotive interior substrates according to claim 1 or 2,
wherein a solid weight ratio of (D)/[(A)+(B)+(C)] is in a range of 20/100 to 100/100.

6. The water-borne coating composition for automotive interior substrates according to claim 1 or 2,
wherein in the resin (B), a glass transition temperature (Tg) of an acrylic polymerization chain segment is 50 to 120° C.
